(19) United States
(12) Patent Application Publication
(10) Pub. No.: US 2014/0019945 A1
(43) Pub. Date: Jan. 16, 2014

(54) SOFTWARE INSTRUMENTATION APPARATUS AND METHOD

(71) Applicants: Henry Young, London (GB); Jonnavithula Sreekanth, Acton, MA (US); Robbie Dhillon, Lincoln, RI (US)

(72) Inventors: Henry Young, London (GB); Jonnavithula Sreekanth, Acton, MA (US); Robbie Dhillon, Lincoln, RI (US)

(73) Assignee: TRADING SYSTEMS ASSOCIATES PLC, London (GB)

(21) Appl. No.: 13/818,957

(22) PCT Filed: Aug. 24, 2010
(86) PCT No.: PCT/GB2010/051398

§ 371 Date: Oct. 1, 2013

(51) Int. Cl. G06F 11/34

(52) U.S. Cl. CPC G06F 11/34
USPC 717/130

(57) ABSTRACT

A method and apparatus for monitoring software events in a computer system comprises a plurality of processors each performing a portion of an overall system task. Each processor has an application portion having one or more threads for performing the portion of the overall task and an application program interface for receiving notification of an event within the portion and transferring data relevant to the overall task portion and indication of occurrence of the event to a common hardware module that time stamps and stores the time of event, the origin of the relevant data, and the relevant data, time stamping being achieved using a highly accurate clock. The system can then send a record of the event, accurately time stamped at the very time of its occurrence, to a remote monitoring site for later assessment.

The present invention relates to a method and apparatus for monitoring the occurrence of computer software generated events in a system, and particularly relates to providing precise timing and reporting of when such events occur.

The objective of software instrumentation is to record some data associated with a particular event, together with a time stamp reflecting the time at which the event occurred. The existing technique for achieving this is for the application concerned to generate the instrumentation data, make a call to the operating system to fetch the current time, and then to write the instrumentation data and time stamp to some form of persistent storage. This technique has two specific problems.

Firstly, the technology used in modern computer systems to maintain a time-of-day clock, and the means of accessing that information accurately, has not kept pace with the increasing CPU clock speeds, and the rates at which real time events occur. For example, in financial trading applications, real time events can occur at a rate of over 1,000,000 per second, which is one event every 1 microsecond. Standard computer system clocks are typically accurate in the millisecond range, and therefore cannot be used to time stamp high event rates with sufficient discrimination between adjacent events.

The present invention seeks to provide hardware enhanced support for time resolution and accuracy in the 10-100 nanosecond range.

Secondly, using standard computer system clocks for software instrumentation, and dealing with the storage of that information, constitutes a performance overhead which detracts from the primary purpose of any application. When dealing with low rate instrumentation, this is not a problem. However, when dealing with extremely high event rates, the instrumentation workload becomes a significant performance overhead for the application.

The present invention seeks to provide hardware enhanced performance offload, removing from the application the need to request time stamps from the operating system, and the performance overhead of writing the instrumentation data plus time stamp to some form of persistent storage. The present invention further seeks to enable the software instrumentation performance overhead of an application to be very significantly reduced.

Code profiling is a development phase source code optimisation activity. It involves compiling an application's source code using a special feature of the compiler to automatically insert instrumentation code throughout the application. At run time, an application build in such a manner will, in addition to its primary purpose, additionally generate and collate diagnostic information about the proportion of execution time spent in various parts of the code. This is termed execution profiling.

There is one notable problem with code profiling. An application instrumented in this manner runs at a small fraction of the execution speed of a normally compiled application. As a consequence, if the application's purpose is to interact with an external environment of rapidly occurring events (a real time environment), then it will not be able to keep up with the events, and in effect will not function correctly. Any information gathered on the application's performance will therefore be of no use.

The present invention seeks to make it possible to build a code profiling system that will, through a significant reduction in the performance penalty of instrumentation, achieve much higher performance levels while generating equivalent execution profiling data.

According to a first aspect, the present invention consists in a computer system, operable to monitor report, store and provide communication of occurrence of events, in the system, the system comprising: one or more a processors, each processor being operable to run an application, each application comprising one or more threads; each application comprising at least one application program interface (API); where each API comprises; means operable to be informed of an event in a thread of the application;

and immediately effective means, operable in response to the API being informed of the event, to transfer and store data, relevant to the application, in time stamping means; the time stamping means being operable, in response to storage of the data, relevant to the application, to prepare an instrumentation message in the form of a time stamp recorded at the time of storage, the identity of the origin of the data to which the time stamp applies, and the data, relevant to the particular application.

According to a second aspect, the present invention consists in a method for monitoring, reporting, storing and providing communication of occurrence of events in an operational processor, the method comprising the steps of: running a respective application on each of one or more a processors, each application comprising at least one thread; running at least one application program interface (API) on each processor, the API being operable to receive notification of a monitored event in the application; the method including the further steps of: in each API, receiving notification occurrence of an event in the application; and on the occurrence of a monitored event, immediately transferring to and storing in time stamping means, data, relevant to the application; in the time stamping means, in response to storage of the data, relevant to the application, preparing an instrumentation message in the form of a time stamp recorded at the time of storage, the origin of the data to which the time stamp applies, and the data, relevant to the particular application.

The invention also provides that the identity of the origin of the data to which the time stamp applies can be an implied identity.

The invention also provides that the time stamping means can be operable to transmit the instrumentation message to a remote monitor for later analysis.

The invention also provides that the system can be operable to execute a plurality of applications or threads; that the time stamping means can comprises clock means; that the time stamping means can comprise a doorbell memory; and that the doorbell memory can be operable to store the data relevant to the particular application or thread in a respective portion of the doorbell memory for the respective one of the plurality of applications or threads.

The invention also provides that the clock means can comprise synchronizing means, operable to synchronize the clock means towards agreement with a reference clock.

The invention also provides that the reference clock can be at least one of: a high precision free running clock; a reference clock source accurately representing real world time; and a reference clock source derived from an atomic clock.

The invention also provides that the time stamping means can be provided in a PCI card.

The invention also provides that the immediately effective means, operable in response to the API being informed of the event to transfer and store data, relevant to the application, in the time stamping means, can include kernel bypass means.

The invention also provides that the reference clock can be derived from GPS satellite signals.

The invention is further explained, by way of example, by the following description, to be read in conjunction with the appended drawings, in which:

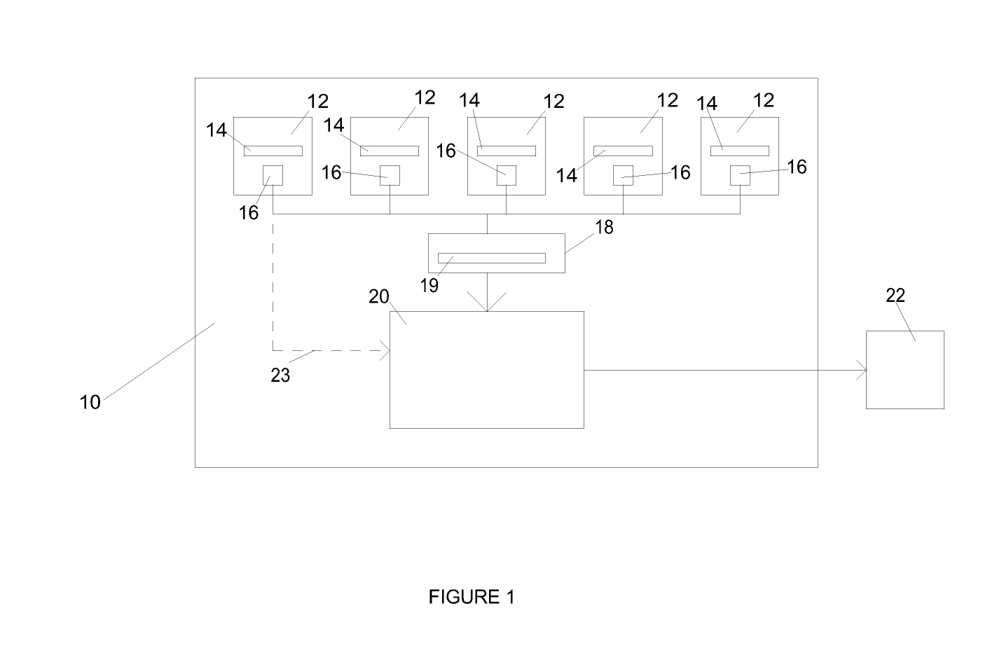

FIG. 1 is a block diagram showing a system suitable for use with the invention.

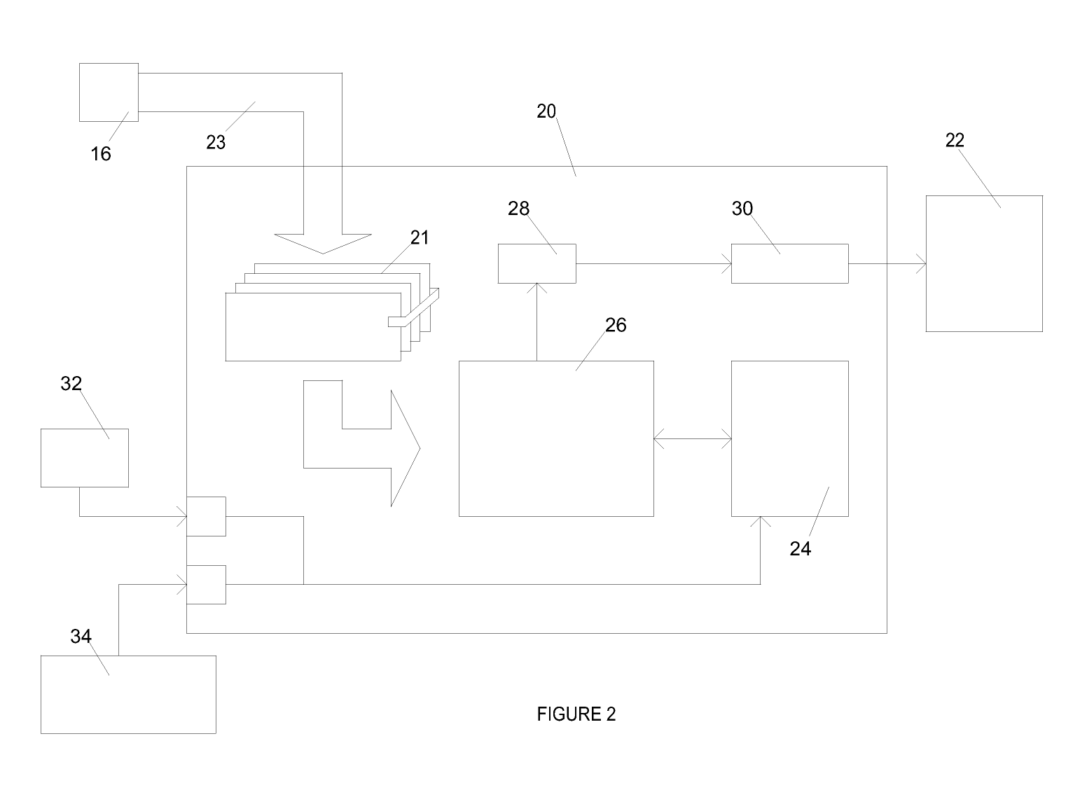

FIG. 2 is a block diagram showing the lower half of FIG. 1 in more detail.

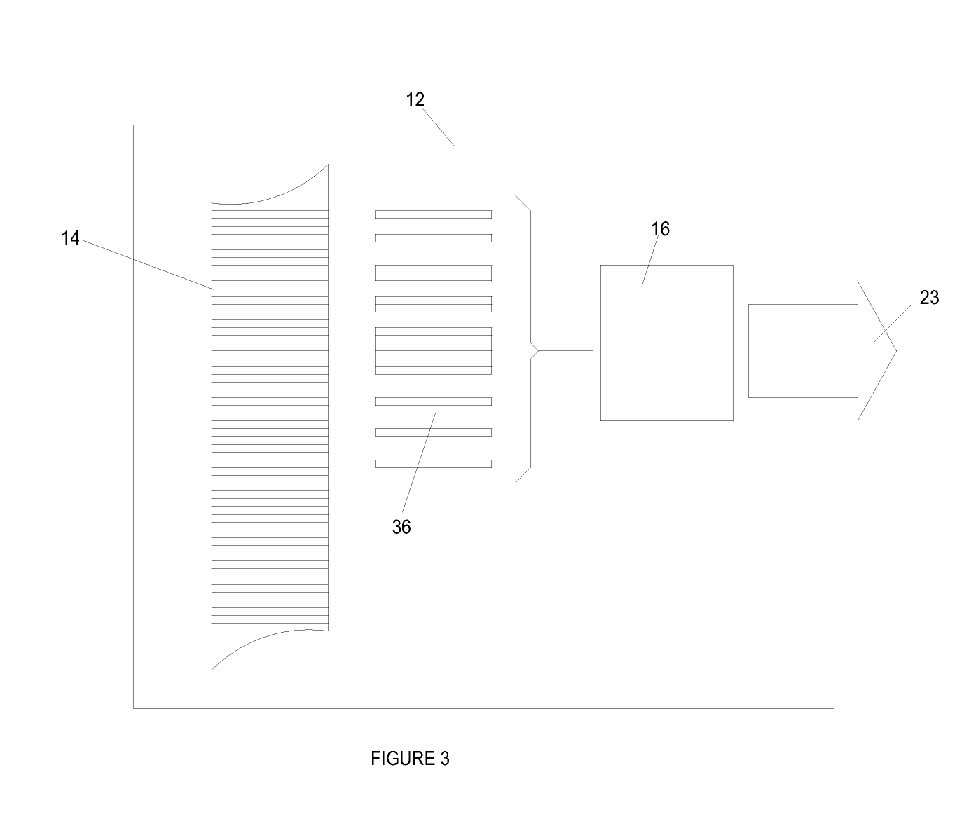

FIG. 3 is a schematic diagram illustrating contents of a processor 12 otherwise shown in FIG. 1 and in FIG. 2.

and

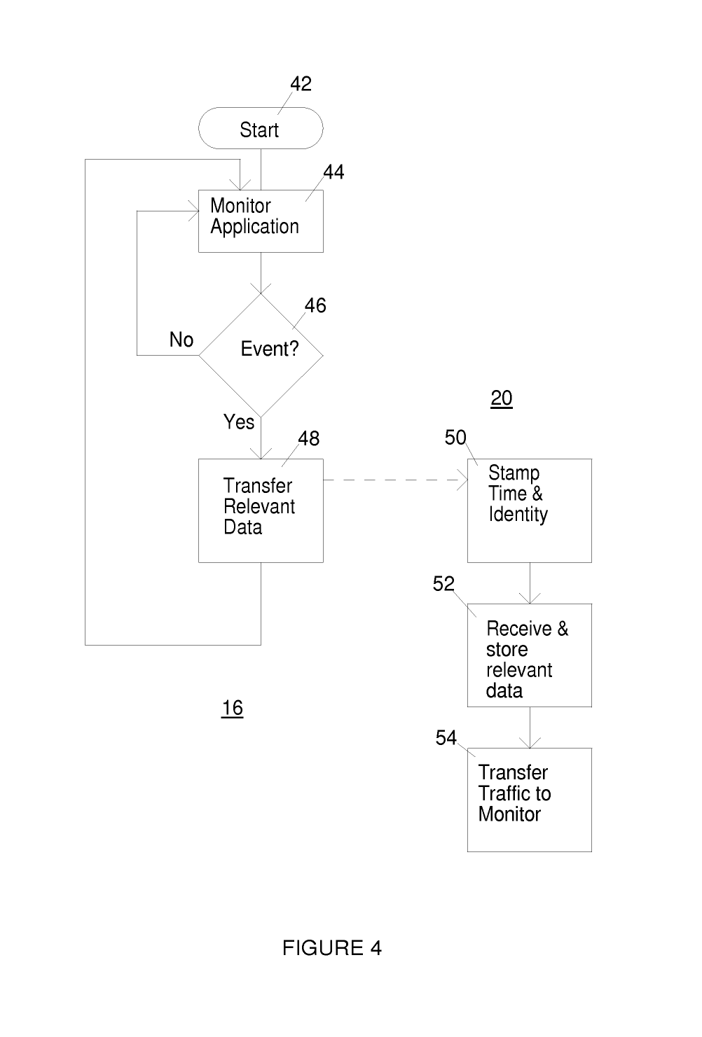

FIG. 4 is a flow chart illustrating, in the left hand column, the activity of a process or thread and, in the right hand column, the activity of a time stamping module.

Attention is first drawn to FIG. 1, a block diagram showing a system suitable for use within the invention.

FIG. 1 illustrates a computer system 10 in which an operating system (not separately illustrated) runs each of a plurality of independent processes 12 each programmed to perform a portion of a collective task. Each process may in turn comprise one or more separate concurrent threads of execution. The independent tasks, in this example, can involve any aspect of trading, ranging, for example, from accessing data, processing data, accessing orders, choosing trading points according to criteria, to executing trades. In other examples, the collective task can involve any aspect of real world interaction where actions and events are required. Each process 12 runs an application, being a single part of the overall operation undertaken by the system 10. The activities of each of the processes 12, when added together, constitute the overall activity of the system 10.

Each process 12 comprises a respective programme application 14 and a respective Application Program Interface (API) 16. An application program interface (API) is an interface implemented by a software component which enables it to interact with other software components. The application 14 performs the business of the process 12 which notifies the API 16 when a monitored event occurs within the respective application 14.

API 16 automatically passes the respective relevant data to an allocated portion of a doorbell memory 21 (provided in a hardware module 20), to be stored together with identification of the process (or thread) 12 providing the event recognition trigger and the time, received from a clock in the hardware module 20, that the event was recognized and stored. The information, stored in the hardware module 20, can then later, at a suitable time, be transmitted out of the system 10 for subsequent storage, analysis and assessment in a remote monitor 22. The hardware module 20 thus acts, in part, as a time stamping means.

The hardware module 20 operates with an operating system 18 for the overall system 10, the operating system 18 providing a driver 19 for the hardware and process of the invention. The APIs 16 in the processes 12 each have the capacity (here represented as a single broken line 23) immediately to communicate relevant data from the respective application 14 to the hardware module 20 when the API is notified that a monitored event occurs.

The data relevant to the respective application 14 is written, at the instant of the API 16 is notified of the respective event, directly by the API 16, to a memory area termed the doorbell memory 21. The write operation is conducted in a manner such that the data is written by the API 16 of the application 14 directly to the physical doorbell memory 21 on the hardware module 20 without involving the use of operating system services, and without requiring any context switch from user mode operation to kernel mode operation. This technique is termed “kernel bypass”. There are multiple banks of doorbell memory 21 to enable multiple processes and threads of execution within applications 14 to make use of the hardware module 20 concurrently without requiring the performance overhead of thread synchronisation.

Attention is next drawn to FIG. 2, a block diagram showing the lower half of FIG. 1 in more detail.

As will become clear when FIG. 3 is described hereafter, the API 16 is notified of the occurrence of a monitored event in the application 14 and automatically, at the instant of recognition, transfers relevant data at the time of the occurrence of the event as written data input to the respective allocated portion of the doorbell memory 21 corresponding to the respective process (or thread) 12. At the same time a clock means 24 is triggered by the respective API 16 storing the relevant data to provide and store a measure of the time at which the data storage occurred in the same respective part of the doorbell memory 21 and an identification of the particular process (or thread) 12 providing data, the process indication also being stored in the same respective part of the doorbell memory 21. Thus, almost immediately after detection by the API 16, of a monitored event for a particular process (or thread) 12, relevant data, time of occurrence of storage and identity of the process (or thread) 12 are all stored in order in the part of the doorbell memory 21 relating to that particular process 12. As each process 12 experiences a monitored event, its record is laid down in the hardware module 20.

The hardware module 20 is run by a fast co-processor which, in this embodiment, is embodied as a Field Programmable Gate Array (FPGA) 26 acting at fast, digital logic speeds. Time of storage is immediately stamped for each event. The hardware module 20 can thus transmit data and details at a later, more convenient time, and independently of any main processor 10 operation, to avoid parasitic use of processor clock cycles, which, in other systems, might have been lost from execution of the application.

The data and details are fed through the FPGA 26 to batching means 28 where they are ordered for sending and then put through a protocol assembler 30 into data transfer protocol such as a series of User Datagram Protocol (UDP) or Transmission Control Protocol (TCP) packets to be sent through a network to the monitor 22 outside the system 10.

The clock means 24 is an extremely accurate clock, whose accuracy is further improved by having synchronizing access to an accurate clock source, conveyed using one of a number of possible techniques. A first accurate clock source 32 can be provided using an analogue clock signalling technique such as Pulse Per Second (PPS). A second accurate clock source 34 can be provided using a digital clock signalling technique such as Precision Time Protocol (PTP). The accurate clock sources so provided may in turn be derived from a GPS master clock unit, which includes an accurate satellite time signal transposed to the position of a GPS receiver by calculation to give an accurate time signal at the GPS receiver. By arranging that a GPS receiver can provide time correction signals to the clock means, accurate time keeping and tracking can be assured by the clock means 24.

It is not always necessary for the clock means 24 to maintain absolute correct time for measurements. If the clock means 24 displays a time displacement, it is sufficient for the time displacement to be the same for each instance of time stamping, in which case no consequential differences will be recorded since all clock means 24 displacements are the same. This is particularly of use for running with reference to a free running temperature compensated crystal oscillator clock, where considerable absolute time errors are possible.

Despite the potential time offset errors, the clock means in the present invention can achieve an absolute best time accuracy of +−10.0 nanoseconds. This time accuracy contrasts with the accuracy exhibited by earlier schemes where accuracies as poor as plus or minus 1.0 milliseconds could be experienced.

Attention is next drawn to FIG. 3, a schematic diagram illustrating contents of a process 12 otherwise shown in FIG. 1 and in FIG. 2.

As described with reference to. FIG. 1, each process 12 embodies the execution of an application 14. The overall system 10 performs a user defined task and each process 12 performs one part of that user defined task. The user has the code that is the application 14 specifically written to perform the required task. Furthermore, the user will have additional code inserted into the application 14 the purpose of which is to detect monitored events and notify the API 16.

When writing and compiling the application 14 using, for example, execution profiling, as described above, one or more areas of the code representing relevant data 36 can be selected. The relevant data 36 is created and collected. When the API 16 is notified of the occurrence of a monitored event, the relevant data 36 is sent, as part of the notification action, to the doorbell memory 21 in the hardware module 20. As an example, relevant data can include, but is not limited to: data values; number of times a resource was accessed; identifying data associated with the event; and a host of other information that might be of use when later analysing the event. As the API 16 executes data transfer, the relevant data 36 is stored with the minimum loss of processor clock cycles and is also time stamped with precision.

Calls to the API 16, which is shown as a separately designated and operating section, can be interspersed inline with the other lines of the code of the application 14. The API 16 is represented as a separate block 16 simply based on its separate purpose from execution of the application 14 and the non application execution related actions it separately executes.

The hardware module 20 is preferably provided, in this example, as a PCI local bus card. The hardware module 20 is described herein as a PCI card. It is to be understood that the invention also comprises the hardware module 20 being embodied as any kind of computer hardware sub-system or module, which can be realised in other forms using hardware interfacing or embedding techniques known to an individual who is skilled in the art.

Attention is next drawn to FIG. 4, a flow chart illustrating, in the left hand column, the exemplary activity of a process 12 and, in the right hand column, the corresponding activity of the hardware module 20. This explanation shows, as a simple example, one of many ways this aspect of the system can operate.

From a start 42 a first operation 44 in the process monitors the progress of the application to see if a monitored event has occurred. If a first test 46 detects that a monitored event has not occurred, control passes back to the first operation. If the first test 46 detects that the monitored event has occurred, control passes to a second operation 48 where the process notifies the API 16 of the occurrence of the monitored event, passing the relevant data 36 to the hardware module 20. That completed, control is then passed back to the first operation 44 to monitor for the next occasion when the monitored event will occur.

The first thing that the hardware module 20 does in a third operation 50 is to apply and store a time stamp from the clock means 24. This is done first so that there can be least delay between occurrence of the event and its time of occurrence being noted. At the same time, a process (or thread) 12 identifier is generated and stored based on the particular process (or thread) in which the event occurred. Thus, the hardware module 20 first records the time of the event and the identity of the process (or thread) 12 involved.

A fourth operation 52 next receives and stores the relevant data 36 which the process (or thread) 12 has transferred to the hardware module 20.

Later, when the hardware module 20 is ready, a fifth operation 54 is used to transfer the time stamped material, otherwise known as instrumentation data, to the remote monitor 22 for analysis.

In the example given, it is preferred that the number of separate processes (or threads) 12, is no more than sixty four. Thus, the doorbell memory 21 has, in this example, sixty four allocated areas, one for each of the possible processes (or threads) 12. It is to be realised that the invention can also encompass fewer or more that sixty four doorbell memory areas.

The invention is more clearly defined by the following claims. Those, skilled in the art, will be aware of variations and modifications which can be applied without departing from the claimed invention.

1. A computer system operable to monitor, report, store and provide communication of occurrence of events in the system, the computer system comprising:
one or more a processors, each processor being operable to run an application, each application comprising one or more threads and at least one application program interface (API), each API comprising:
means operable to be informed of an event in a thread of the application; and
immediately effective means operable, in response to the API being informed of the event, to transfer and store data, relevant to the application, in time stamping means, the time stamping means being operable, in response to storage of the data, relevant to the application, to prepare an instrumentation message in the form of a time stamp recorded at the time of storage, the identity of an origin of the data to which the time stamp applies, and the data, relevant to the particular application.

2. The system according to claim 1, wherein an identity of the origin of the data to which the time stamp applies is an implied identity.

3. The system according to claim 1, wherein further comprising a remote monitor, the time stamping means being operable to transmit the instrumentation message to the remote monitor for later analysis.

4. The system according to claim 1, wherein;
the one or more processors are operable to execute a plurality of applications or threads;
the time stamping means comprises clock means; and
the time stamping means comprises a doorbell memory;
wherein the doorbell memory is operable to store the data relevant to a particular one of the applications and threads in a respective portion of the doorbell memory for the respective one of the plurality of the applications and the threads.

5. The system according to claim 4, further comprising a reference clock, the clock means comprising synchronizing means operable to synchronize the clock means towards agreement with the reference clock.

6. The system according to claim 5, wherein the reference clock is at least one of:
a high precision free running clock;
a reference clock source accurately representing real world time; and
a reference clock source derived from an atomic clock.

7. The system according to claim 1, further comprising a PCI card, the PCI card comprising the time stamping means.

8. The system according to claim 1, wherein the immediately effective means, operable in response to the API being informed of the event to transfer and store data, relevant to the application, in the time stamping means, includes kernel bypass means.

9. A method for monitoring, reporting, storing and providing communication of occurrence of events in an operational processor, the method comprising the steps of:
running a respective application on each of one or more a processors, each application comprising at least one thread;
running at least one application program interface (API) on each of the processors, the API being operable to receive notification of a monitored event in the application;
in each API, receiving notification occurrence of an event in the application; and
on the occurrence of a monitored event, immediately transferring to and storing in time stamping means, data, relevant to the application;
in the time stamping means, in response to storage of the data, relevant to the application, preparing an instrumentation message in the form of a time stamp recorded at the time of storage, an origin of the data to which the time stamp applies, and the data, relevant to the particular application.

10. The method according to claim 9, wherein an identity of the origin of the data to which the time stamp applies is an implied identity

11. The method according to claim 9, including the step of providing the instrumentation message to a remote monitor for later assessment.

12. The method of claim 9, further comprising the steps of:
with a plurality of processors:
maintaining a clock;
providing a doorbell memory; and
storing the instrumentation message in a respective portion of the doorbell memory for the respective one of the application or thread in the respective processor.

13. The method according to claim 12, including the step of synchronizing the maintained clock towards agreement with an accurate reference clock.

14. The method according to claim 13, wherein the accurate reference clock source is at least one of:
a high precision free running clock;
a reference clock source accurately representing real world time; and
a reference clock source derived from an atomic clock.

15. The method according to claim 9, including the step of providing the time stamping means as a PCI card.

16. The method according to claim 9, including the step of employing kernel bypass to transfer and store data, relevant to the application, into the time stamping means.

17. A computer system operable to monitor, report, store and provide communication of occurrence of events in the system, the computer system comprising:
one or more processors, each processor being operable to run an application, each application comprising one or more threads and at least one application program interface (API), each API comprising:
an event informer operable to be informed of an event within at least one of the threads of the application; and
a transfer and storage mechanism operable, in response to the API being informed of the event, to transfer and store data, relevant to the application, in a time stamper, the time stamper being operable, in response to storage of the data, relevant to the application, to prepare an instrumentation message in the form of a time stamp recorded at the time of storage, an identity of an origin of the data to which the time stamp applies, and the data, relevant to the particular application.

18. The system according to claim 18, wherein the time stamper is operable to transmit the instrumentation message to a remote monitor for later analysis.

19. The system according to claim 18, wherein;
the one or more processors are operable to execute a plurality of at least one of the applications and the threads;
the time stamper comprises a clock and a doorbell memory, the doorbell memory being operable to store the data relevant to the particular at least one of application and thread in a respective portion of the doorbell memory for the respective one of the plurality of the applications and the threads.

20. The system according to claim 19, further comprising a reference clock, the clock comprising a synchronizer operable to synchronize the clock towards agreement with the reference clock.
